(19) United States
(12) Patent Application Publication
(10) Pub. No.: US 2010/0100742 A1
(43) Pub. Date: Apr. 22, 2010

(54) Transport Stream Watermarking

(76) Inventors: Jeffrey M. Courington, Chester, VA (US); Randal A. Eye, Mechanicsville, VA (US); Jeffrey H. Segal, Midlothian, VA (US); Thomas Siner, Chesterfield, VA (US)

Correspondence Address: DOLBY LABORATORIES, INC., 999BRANNAN STREET, SAN FRANCISCO, CA, 94103, US

(21) Appl. No.: 12/058,185

(22) Filed: Mar. 28, 2008

Related U.S. Application Data
(60) Provisional application No. 61/029,401, filed on Feb. 18, 2008.

(51) Int. Cl. H04L 9/00

(52) U.S. Cl. 713/176

(57) ABSTRACT

Methods and apparatuses for processing and watermarking a transport stream with a message. A processed transport stream that includes processed content packets, associated carrier packets, and a watermark descriptor for a group of the associated carrier packets is created from the transport stream. The processed content data represent a first watermark value and are bounded by transport sector boundaries. The associated carrier packets include replacement watermark data that represent a second watermark value and are bounded by transport sector boundaries. These associated carrier packets are paired with processed content packets. The watermark descriptor includes synchronization data. A watermarked transport stream is created by interleaving selected processed content packets and associated carrier packets according to a watermark message.

### CROSS REFERENCE TO RELATED APPLICATIONS

The present application claims the benefit of provisional patent application Ser. No. 61/029,401 to Courington et al., filed on Feb. 18, 2008, entitled “Transport Stream Watermarking,” which is hereby incorporated by reference.

### BACKGROUND

Digital watermarks are data embedded into digital content such as digital audio and video that may be readable by computers. Watermarks may be used for various purposes. One type, forensic watermarks, is used to identify the source and/or distribution path (e.g., source of copying) of legitimate content that is copied without authorization. An example of a distribution path is the specific set-top box that played the content prior to copying. These marks should, inter alia, be invisible (or inaudible), be able to resist intentional and unintentional attempts of deletion, and be recoverable with sufficient assurance so that they can be relied upon for incriminating individuals fairly.

Forensic watermarking is an anti-piracy tool that compliment Data Rights Management (DRM) systems DRMs and Conditional Access (CA) systems. Forensic watermarking can be defined as the embedding of a message within the video that identifies the last authorized party. A forensic watermark can be placed in content at various points along its distribution. If content is found outside of an authorized distribution path, the forensic watermark contained in the content can be used to identify the source of the leak.

Today, content distributors and system operators often insert a watermark that identifies the system operator. This practice is often of limited help in identifying pirates. It may be the case that system operators are much more interested in placing a forensic watermark at their head-ends, at interim points along the distribution path, and in the consumer playback device itself. This systematic use of forensic watermarks can, at the very least, identify most of the path(s) to an authorized consumer and eliminate the opportunity for anonymous redistribution. It may also provide a way to monitor the overall integrity of DRM and CA systems. Such monitoring helps raise awareness of when a leak is present so that a system operator can adjust or renew their security system to prevent or stop such leak.

Forensic watermarking has already proven very useful in professional video applications, including for example pre-release movie screeners on DVD. Forensic watermarking has also been specifically designed to enable forensic watermarking in consumer applications.

A forensic watermark solution for consumer markets may work across a broad range of playback devices, including, but not limited to, personal computers, set-top boxes, portable media players and mobile phones. To support such a wide range of playback platforms, the forensic watermark should be robust but also require minimal processing power to insert a message. Also, to stay ahead of pirates, it should be renewable without having to update the deployed consumer playback devices. Additionally, to track the path of distribution, the forensic watermarking system should support multiple insertions of marks and be able to recover such marks without any reference to the original digital video content.

Various advantages exist for some embodiments directed to consumers. For example, a “compute-efficient” watermark inserter can be deployed across the entire field of consumer digital media players, including currently fielded models. The “compute-efficient” watermark inserter may insert a unique identifier, such as device ID and date/time of playback. Another advantage is that the system is renewable and can support a “blind” watermark recovery system that requires no information about the original source content, channel of content distribution, or player. Source based recovery is also available with no change to the playback watermark inserter.

Some forensic watermarking technologies may be used in the consumer market to solve critical content rights problems. One such problem is movie content piracy—particularly as play windows collapse and high definition content comes to consumer markets. However, forensic watermarking may also be useful in testing the integrity of a distribution channel, thereby protecting the revenue stream of the system operator by identifying where their system is allowing unauthorized access to programming. This testing may become particularly important as DRMs become more interoperable and the content distribution path includes two or more DRMs, and where system operators want to expand into new types of services, such as network hosted personal video recorders (Virtual PVRs).

To the content owner, forensic watermarking may provide a definitive link between a pirated copy of their content and the legitimate channel where the copy originated. This technology has proven to be a useful tool for identifying and tracking down large scale and individual pirates.

To the system operator, forensic watermarking may provide a tool to positively link (or disassociate) a pirated copy of content to their distribution system. This aspect means that system operators can identify where security in their system needs to be renewed. Once identified, system operators may be able to better manage their operating costs and reduce revenue losses. It may also mean that they can make a case with the content owner for higher value content, and thus increase the value of programming.

To the consumer, forensic watermarking may act to “keep honest people honest.” In the same way that a consumer will not try to steal clothing from a shop with sensors at the door, that same consumer would not illegally distribute content that had a watermark that could be tied back to them.

Forensic watermarking may supplement some DRM systems. In some applications, forensic watermarking may be used to continue to provide protection once the content leaves the DRM envelope.

FIG. 1 is a block diagram showing a traditional pre-encrypted video-on-demand (VOD) system capable distributing a pre-encrypted transport stream. As illustrated, unencrypted content 100 is encrypted using an encryption engine 120 using encryption keys provided by CA module 180. The encrypted content 130 may then be distributed by way of a VOD server 140 through a network 150 to a set-top-box (STB) 160. The STB 160 may decrypt the encrypted content stream 130 using a key obtained through CA module 180 for viewing on a users television set 170. With such a system, watermarks are generally applied to the unencrypted transport stream 110 before distribution.

Users of such traditional watermarking systems include video distribution systems, such as Video-on-Demand (VOD) and web-based downloads, encrypt content prior to storage on the distribution servers. The Conditional Access (CA) system 180 provides encryption keys to the encryptor 120 at the point of content ingest, and to the CA modules at the content viewing point 160 (generally, this is the smartcard at the set-top-box).

Video forensic watermarking processes require access to unencrypted content 110 to perform analysis and modification of the video. Because of this, a content distribution system using a traditional watermarking system to embed a unique watermark on each downloaded stream has three options. First, store the content unencrypted. This solution has obvious security implications, but also does not address the high-performance goals of a large distribution system. Second, use a partial-encryption scheme. While this is a fairly popular field of discussion, this solution is only marginally better than storing the content unencrypted. Even if it succeeds in encrypting a majority of the data, the distributed content has unencrypted portions that may act as markers for the location of watermarks. Also, this solution may have unaddressed performance issues. Third, store the content encrypted and then decrypt it to perform watermarking.

A distribution system that satisfies the third option is illustrated in FIG. 2. This system allows for content to be completely encrypted both in storage and in transmission. For a standard watermark application, however, it is necessary for this system to decrypt the content (using decryption engine 210), apply the watermark (using watermark inserted 220) and re-encrypt the content (using encryption engine 230) before transmission by VOD server 140. This is true whether or not the watermark insertion is in the compressed or baseband domains.

This method has several undesirable characteristics. First, The VOD server may need to be able to decrypt content from every CA vendor. Second, the VOD server may need to support decrypt/encrypt for numerous simultaneous streams. Third, the content may be in the clear briefly on the VOD server. It is generally considered unacceptable for the CA to allow any additional entities (such as the VOD server) to have access to content keys.

What is needed is a secure distribution system capable of: storing content completely encrypted, and uniquely watermarking individual content deliveries without requiring any content decryption (i.e., watermarking the individual content deliveries in the encrypted domain).

### BRIEF DESCRIPTION OF THE SEVERAL VIEWS OF THE DRAWINGS

FIG. 1 is a block diagram of a pre-encrypted video-on-demand (VOD) system.

FIG. 2 is a block diagram of a pre-encrypted VOD system that uses tradition watermarking.

FIG. 3 is a block diagram of a pre-encrypted VOD system that uses tradition watermarking.

FIG. 4 is a block diagram of an encrypted-domain watermarking system as per an aspect of an embodiment of the present invention.

FIG. 5A is a block diagram showing groups of carrier packets preceded by a watermark descriptor (WMD) being multiplexed into a transport stream containing video packets as per an aspect of an embodiment of the present invention.

FIG. 5B is a block diagram showing groups of carrier packets preceded by a WMD being multiplexed into a transport stream containing video packets as per an aspect of an embodiment of the present invention.

FIG. 6 is a block diagram of a transport stream watermarking system as per an aspect of an embodiment of the present invention.

FIG. 7 is a block diagram showing select elements of a transport stream as per an aspect of an embodiment of the present invention.

FIG. 8 is a block diagram showing select elements of a processed transport stream as per an aspect of an embodiment of the present invention.

FIG. 9 is a block diagram showing related processed content packets and associated carrier packets as per an aspect of an embodiment of the present invention.

FIG. 10 is a block diagram showing related processed content packets and associated carrier packets with data aligned with cryptographic blocks as per an aspect of an embodiment of the present invention.

FIG. 11A is a block diagram of a larger transport stream as per an aspect of an embodiment of the present invention.

FIG. 11B is a block diagram of a larger processed transport stream as per an aspect of an embodiment of the present invention.

FIG. 12 is an expanded block diagram of a transport stream processor as per an aspect of an embodiment of the present invention.

FIG. 13 is an expanded block diagram of an alternative transport stream processor as per an aspect of an embodiment of the present invention.

FIG. 14 is an expanded block diagram of a processed transport stream watermarker as per an aspect of an embodiment of the present invention.

FIG. 15 is a flow diagram showing the creation of a watermarked transport stream as per an aspect of an embodiment of the present invention.

FIG. 16 is a flow diagram showing the creation of a processed transport stream as per an aspect of an embodiment of the present invention.

FIG. 17 is a flow diagram showing an alternative method to create a processed transport stream as per an aspect of an embodiment of the present invention.

FIG. 18 is a flow diagram showing the marking of a processed transport stream with a watermark message as per an aspect of an embodiment of the present invention.

FIG. 19 is a flow diagram showing an alternative method for marking a processed transport stream with a watermark message as per an aspect of an embodiment of the present invention.

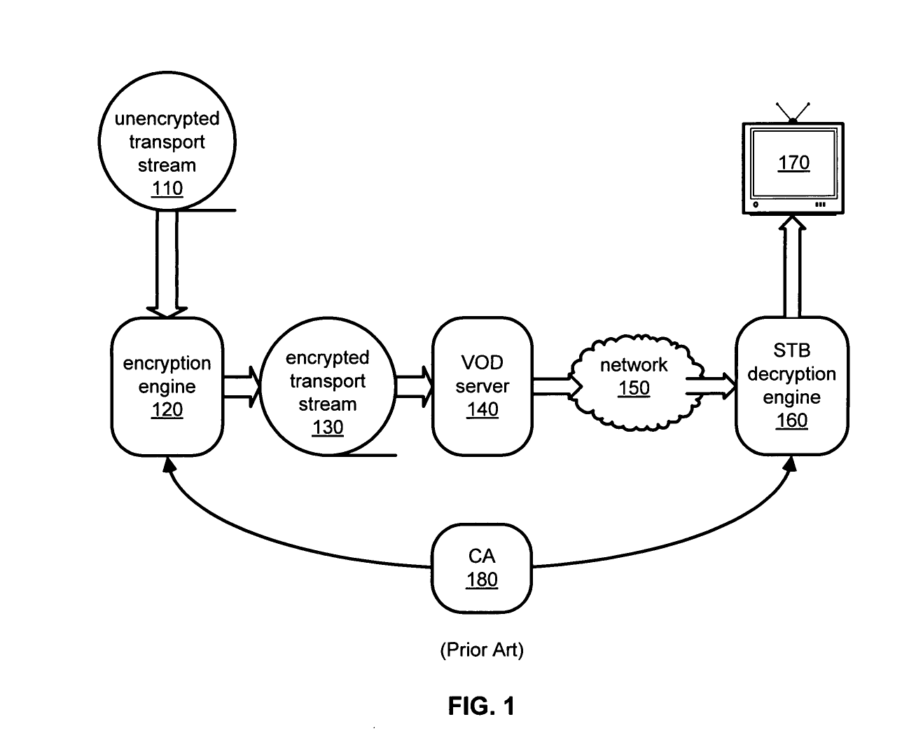

### DETAILED DESCRIPTION OF EMBODIMENTS

Embodiments of the present invention enable real-time watermarking of transport streams without the need to encrypt, decrypt, compress or decompress content streams to apply the watermark. Several of these embodiments will now be described in detail with reference to the accompanying drawings. It should be understood that the embodiments and the accompanying drawings have been described for illustrative purposes and that the present invention is limited only by the claims.

One possible use of the embodiments is apply forensic watermarking to digital content such as movies or audio. Forensic watermarking includes steganographic techniques that allow content providers to manage and track content to specific locations. As one example, forensic watermarking can be useful in monitoring the integrity of Data Rights Management (DRM) systems and Conditional Access (CA) systems described earlier.

The embodiments described in the figures are described using block diagrams and flowcharts, many of the actions and blocks described in both the block diagrams and flow charts may be implemented using functional modules. One skilled in the art will recognize that the modules that may be implemented in software, hardware, programmable hardware such as ASICS, FPGA's, etc, or a combination thereof. Modules may include a digital stream reception hardware that immediately is processed by software, hardware or combinations of software and hardware.

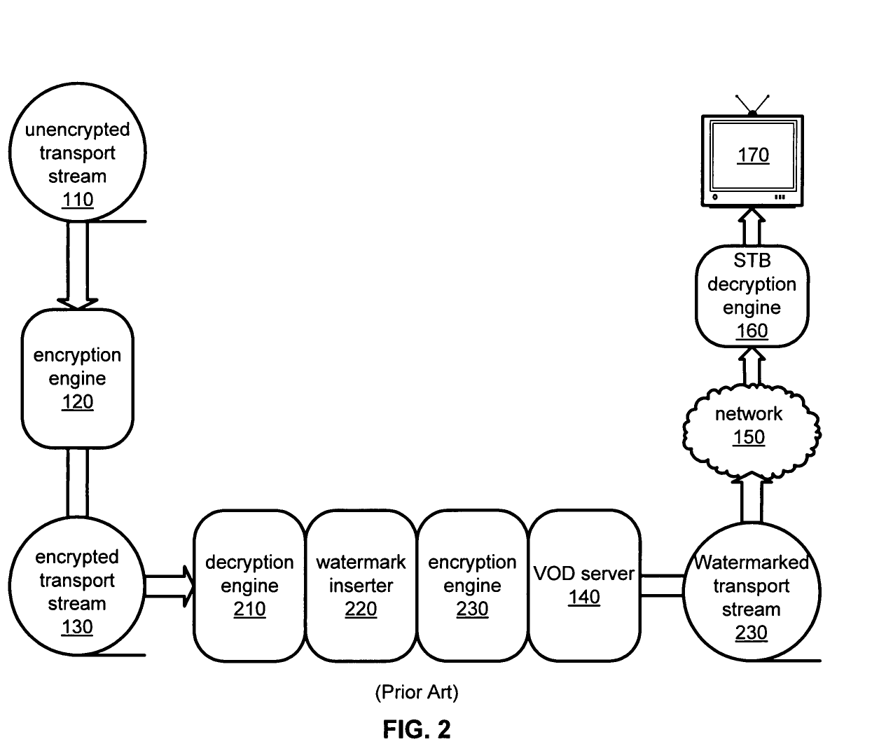

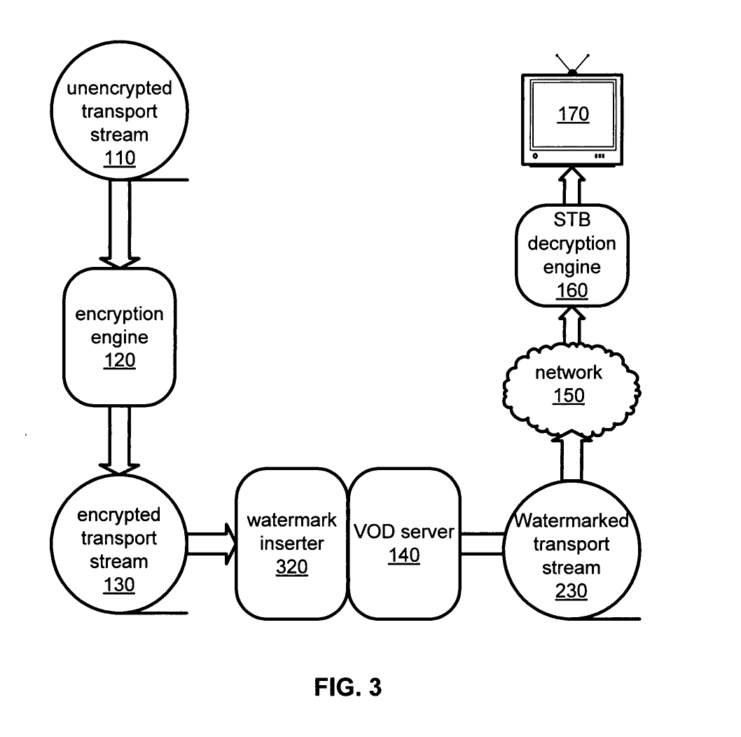

FIG. 3 is a block diagram of a pre-encrypted video-on-demand (VOD) system that uses tradition watermarking in a similar manner as that shown in FIG. 2. In this system, the watermark inserter 320 would need to decrypt the encrypted content stream 130, apply the watermark, and then re-encrypt the content stream.

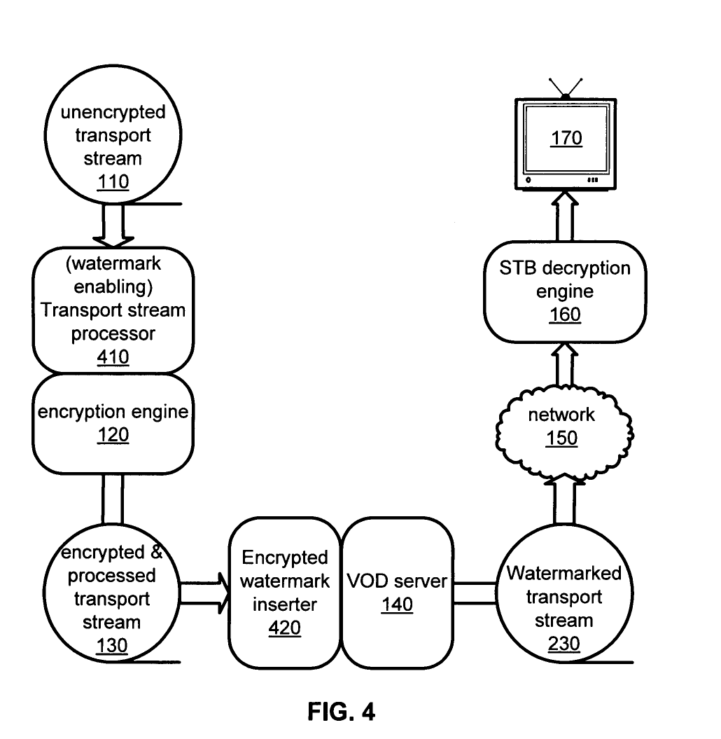

FIG. 4 shows an improvement to that design that may be used to construct a secure distribution system capable of (a) storing content completely encrypted, and (b) uniquely watermarking individual content deliveries without requiring any content decryption (i.e., watermarking the individual content deliveries in the encrypted domain). As shown in FIG. 4, the unencrypted transport stream 110 may be processed with a watermark enabling transport stream processor (also referred to herein as Watermark Processor (WP)) 410. This watermark enabling transport stream processor 410 now enables the watermarking of an encrypted processed transport stream 130 by an encrypted watermark inserter 420 without having to go through the traditional steps of decryption, watermarking and re-encryption illustrated in FIG. 2 and FIG. 3. In addition, aspects of several of the disclosed embodiments may insert watermarks into the individual content deliveries using very little computational power on the distribution server, allowing for large numbers of uniquely-marked content streams to be distributed simultaneously.

The content processed in these embodiments may include muxed audio/video transport stream(s) with at least the payload of the video PID being encrypted. The content may be encrypted prior to storage on the distribution server and may not need to be decrypted until it reaches the set-top box (STB). These embodiments should: (1) provide security of the content asset while it is in storage and transmission; (2) maintain the integrity of the content key by not releasing it from the CA domain; (3) the distribution server, including the watermark insertion process, may be agnostic to the encryption method used by the CA; (4) the distribution server, including the watermark insertion process, may be agnostic to the content compression (codec) being used; and (5) the embodiments should not require significant computational resources, thereby not artificially limiting simultaneous stream processing.

While this document specifically describes a transport stream implementation, the technique may work equally well for many other packaging formats such as QuickTime, 3GPP and MP4.

As shown in FIG. 4, embodiments of the present invention may insert a WP component 410 before the CA encryption engine 120. The WP packages the watermark data in such a way as to allow the inserter to perform a message insertion without looking at the encrypted video or encrypted carrier payloads.

This solution builds on previous art for video watermarking in the compressed domain. An example of such prior art may be found in U.S. Pat. No. 6,285,774 to Schumann et al. entitled “System and Methodology for Tracing to a Source of Unauthorized Copying of Prerecorded Proprietary Material, Such As Movies.” A new feature here is the introduction of a Watermark Descriptor (WMD) that allows the inserter 420 to perform its duties without looking at the content of the video or the carrier packets.

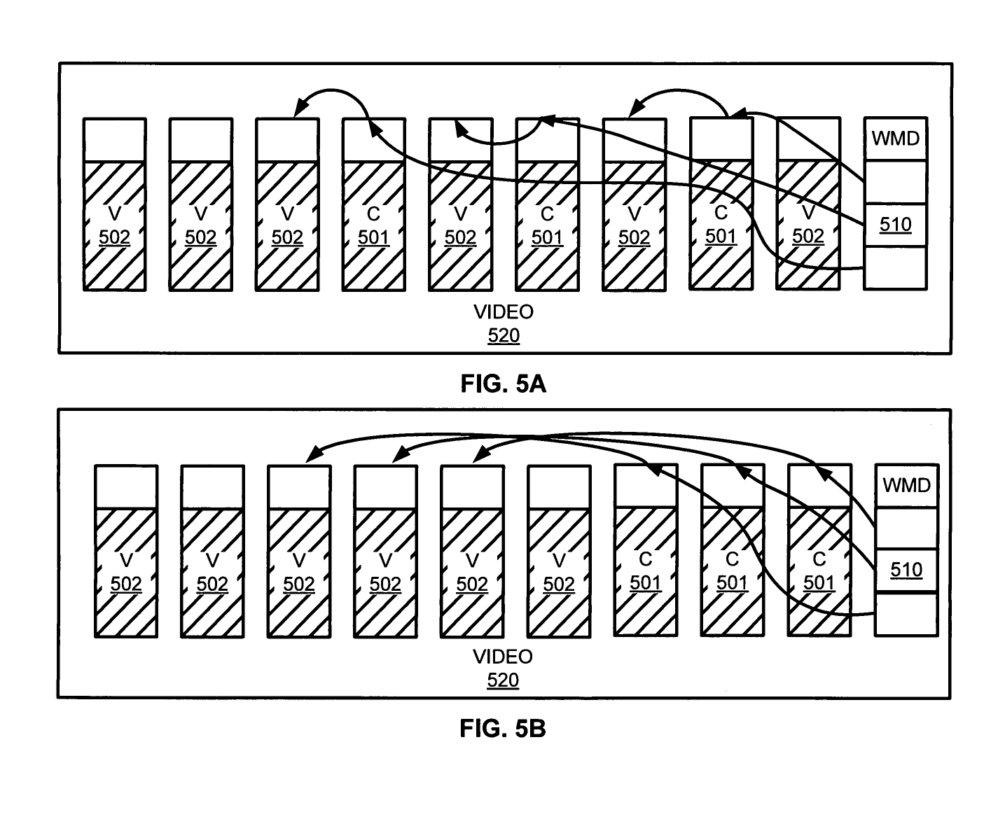

FIGS. 5A and 5B shows groups of carrier packets 501 preceded by a WMD 510 being multiplexed into a transport stream containing video packets 502 as per an aspect of an embodiment of the present invention. The WMD 510 contains the information necessary to replace the video packets 502 with the carrier packets 501 as determined by the message that is being embedded. The WMD 510 contains the bit count, associated packet sequence number, and the number of carrier packets for each insertion in a particular frame of video data. Other header information from the video packets may also be used to help synchronize the insertion process, such as a continuity counter. The WMD packet(s) 510 may directly precede the carrier packets 501 and video packets 502, thus providing the necessary synchronization point. The WMD 510 information may be carried in the TS packet adaptation field, thereby ensuring that it is not encrypted.

Within the transport stream, the carrier data (including WMD packets 510) may be stored in a different PID than the video content. The encrypted carrier packets are a 1-for-1 replacement for the encrypted video packets. Each of the video packets 502 and carrier packets 501 should be encrypted in such a way as to not rely on the previous or following data packets. This is normally the case. Since the inserter does not need to look at any of the payload in the video or carrier packets, it is acceptable if the entire payload is encrypted.

Based on the message to be conveyed, the encrypted watermark inserter 420 determines if the encrypted video (representing a ‘0’) or the encrypted carrier (representing a ‘1’) should be in the output video stream. If the encrypted watermark inserter needs to convey a ‘0’ in the stream, the carrier is disregarded and the video is allowed to pass through unaltered. If the encrypted watermark inserter needs to convey a ‘1’ in the stream, then the header from the encrypted video packet (in this case, the 4-byte transport stream header) may be copied over the header of the encrypted carrier packet and the encrypted carrier packet is released while the encrypted video packet is disregarded. (The header from the encrypted video must be copied into the encrypted carrier packet so that the PID and continuity counter are correct for the video stream.)

As shown in the examples illustrated in FIG. 5A and FIG. 5B, the carrier packets can be muxed into the transport stream in several different ways. FIG. 5 shows carrier packets muxed in an interleaved pattern directly before the associated video. This inserter is only required to hold 1 TS (188 bytes) of information. This may be an optimal implementation and is probably the best for embedded applications such as FPGA and ASICs. FIG. 5B shows carrier packets muxed so that they all precede the first video packet. In this embodiment, the inserter will need to queue up to a predefined maximum number of transport sectors. This may be the most straight forward implementation but will mean that the inserter will need to have a larger amount of associated storage for buffering the carrier packets until they are needed for the insertion.

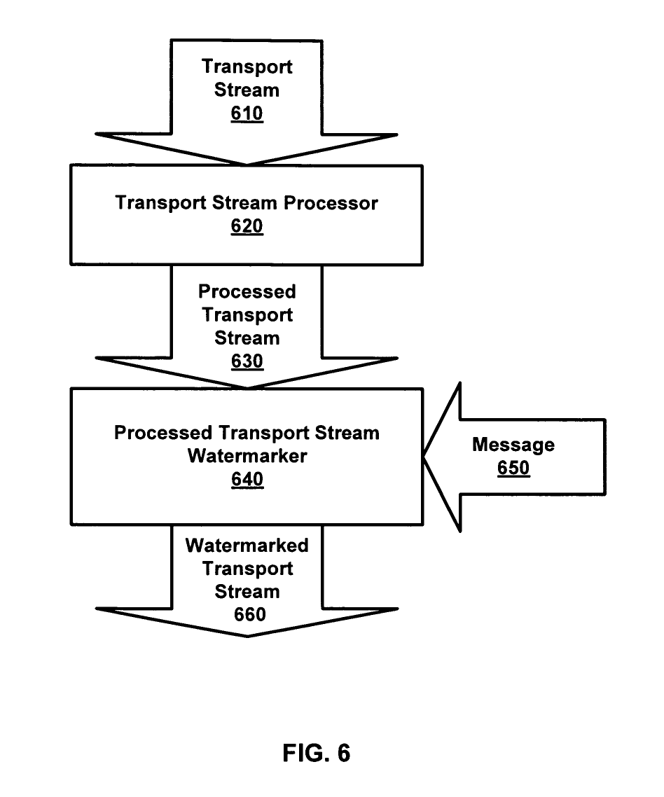

FIG. 6 is another block diagram of a transport stream watermarking system as per an aspect of an embodiment of the present invention. This high level figure shows two important elements that enable the task of watermarking a data stream in real-time: a transport stream processor and a processed transport stream watermarker. A transport stream 610 may be processed by a transport stream processor 620. This transport stream processor will generate a processed transport stream that will contain enough elements to allow a processed transport stream watermarker 640 to generate a watermarked transport stream 660 by encode message 650 into the transport stream.

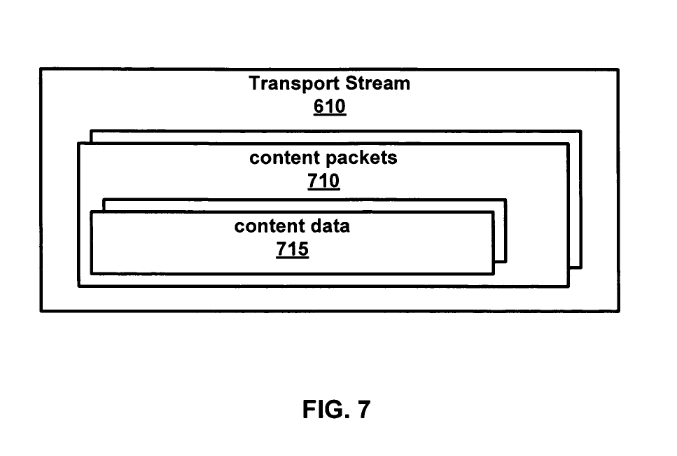

FIG. 7 is a block diagram showing select elements of a transport stream 610 as per an aspect of an embodiment of the present invention. A transport stream 610 generally includes content packets 710, which generally include content data 715.

The transport stream may be an unencrypted transport stream. However, one skilled in the art may practice embodiments where the transport stream may be encrypted. What is important that some kind of content data be extractable in order to generate processed content packets and/or replacement content packets. The transport stream 610 may be any kind of transport stream that includes content data 715 embedded in content packets 710. Examples of such transport streams 610 include MPEG2 transport streams and MPEG2 program stream. Similarly, the content data 715 may of many types including audio data, video data, database data, instructional data, XML data, etc. The content packets 710 should generally be a packaging format suitable for the specific type of content data 715. For example, when the content data 715 includes video data, the content packets may be in a format such as Quicktime, 3GPP or MPEG4.

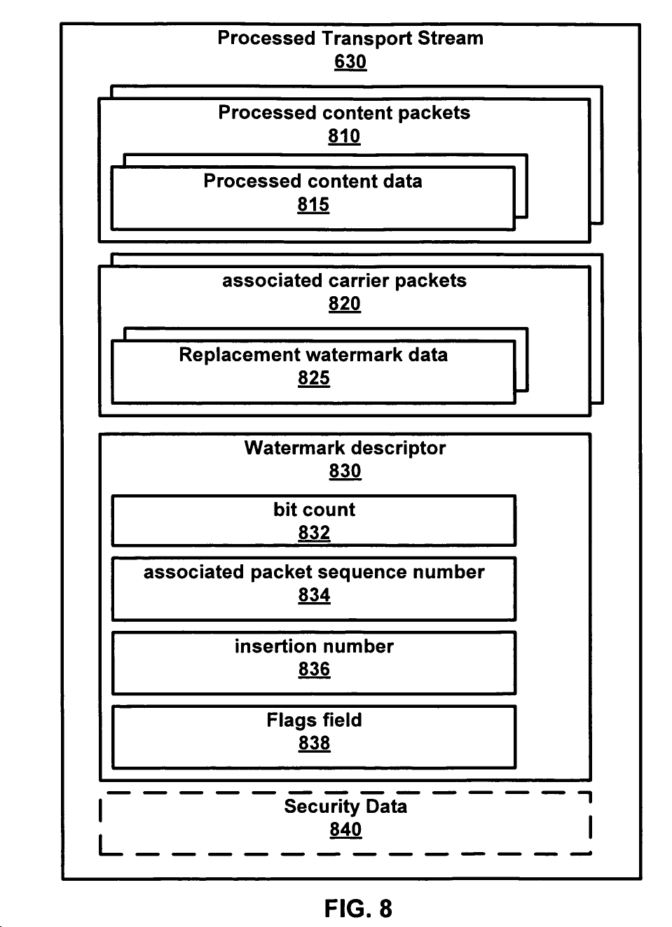

FIG. 8 is a block diagram showing select elements of a processed transport stream 630 as per an aspect of an embodiment of the present invention. The processed transport stream 630 may include processed content packets 810, associated carrier packets 820, and a watermark descriptor 830. The processed content packets may include processed content data 815 whose value represents a first watermark value (e.g. a ‘0’). The associated carrier packets 830 may be paired with related processed content packets 810 wherein the associated carrier packets 830 including replacement watermark data 825 for the processed content data 815. The replacement watermark data 825 may represent a second watermark value (e.g. a ‘1’).

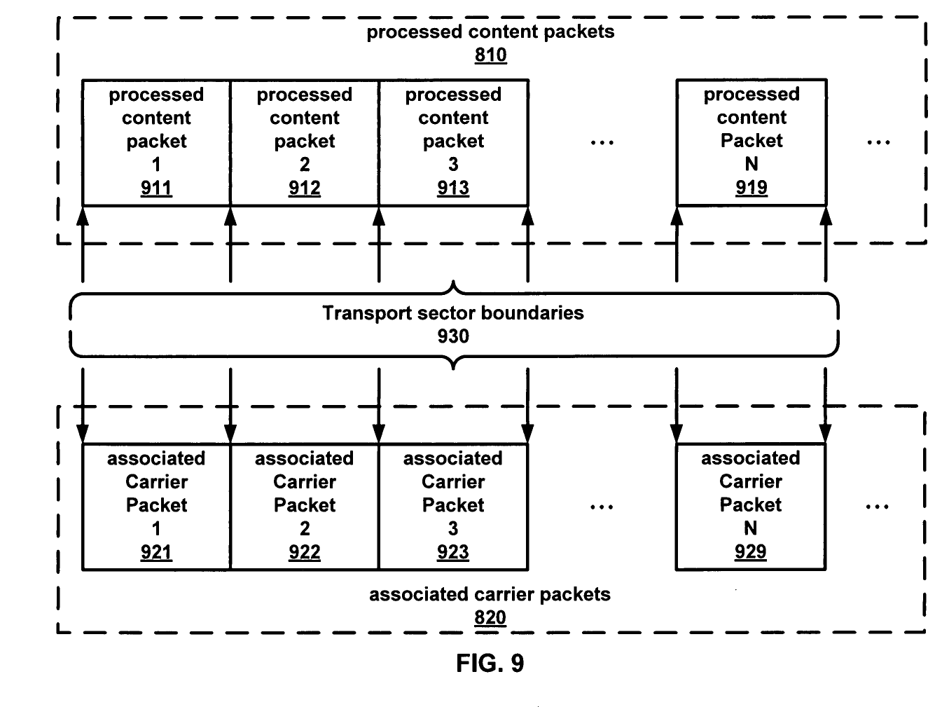

FIG. 9 is a block diagram showing related processed content packets 810 and associated carrier packets 820 as per an aspect of an embodiment of the present invention. As shown, the processed content packets 810 may include a multitude of processed content packets 911, 912, 913 and 919. Similarly, the associated carrier packets 820 may include a multitude of associated carrier packets 921, 922, 923 and 929. These associated packets may be paired so that, for example, processed content packet 911 is paired with associated carrier packet 921, processed content packet 912 is paired with associated carrier packet 922, processed content packet 913 is paired with associated carrier packet 923, and processed content packet 919 is paired with associated carrier packet 929. In the process of creating a watermarked process stream, a specific carrier packet 911 (with a representative value of ‘0’) may be substituted for the specific processed content packet 921 (with a representative value of ‘1’) associated with a the specific carrier packet 911 if a value of ‘1’ is needed in creating in the watermark. To facilitate this exchange, it may be important for the processed content packets 810 and the associated carrier packets 911, 912, 913 and 919 to be bounded by transport sector boundaries 921, 922, 923 and 929.

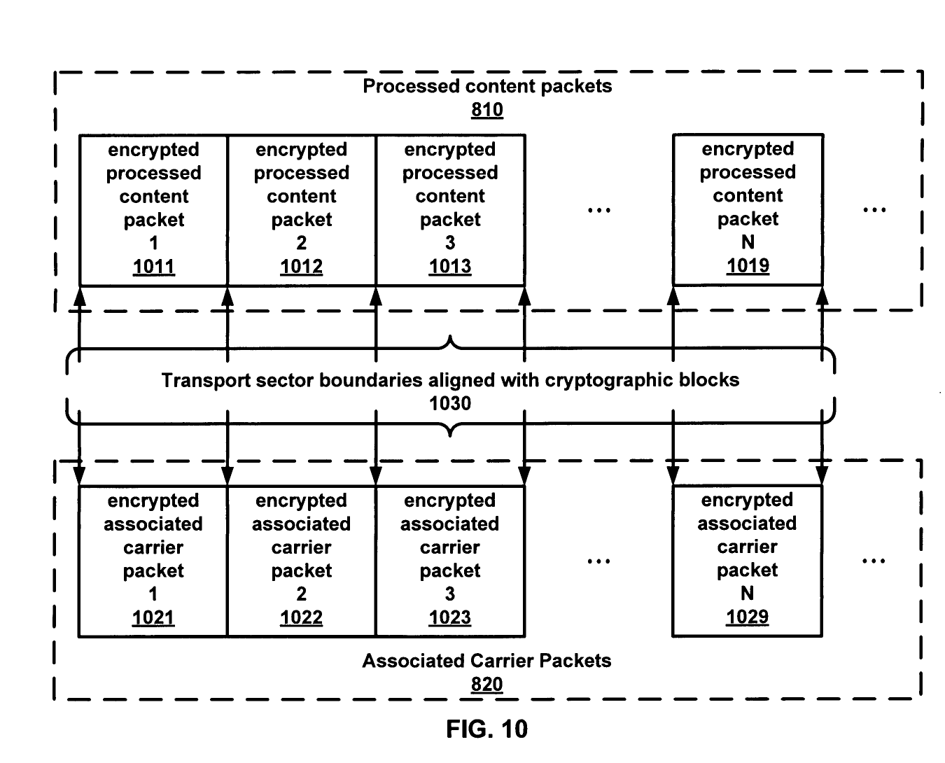

FIG. 10 is a block diagram showing related processed content packets 810 and associated carrier packets 820 with data aligned with cryptographic blocks as per an aspect of an embodiment of the present invention. As shown, the processed content packets 810 may include a multitude of encrypted processed content packets 1011, 1012, 1013 and 1019. Similarly, the associated carrier packets 820 may include a multitude of encrypted associated carrier packets 1021, 1022, 1023 and 1029. These encrypted associated packets may be paired so that for example, encrypted processed content packet 1011 is paired with encrypted associated carrier packet 1021, encrypted processed content packet 1012 is paired with encrypted associated carrier packet 1022, encrypted processed content packet 1013 is paired with encrypted associated carrier packet 1023, and encrypted processed content packet 1019 is paired with encrypted associated carrier packet 1029. In the process of creating a watermarked process stream, a specific encrypted carrier packet 1011 (with a representative value of ‘0’) may be substituted for the specific encrypted processed content packet 1021 (with a representative value of ‘1’) associated with a the specific encrypted carrier packet 1011 if a value of ‘1’ is needed in creating in the watermark. To facilitate this exchange, it may be important for the encrypted processed content packets 1011, 1012, 1013 and 1019 and the encrypted associated carrier packets 1021, 1022, 1023 and 1029 to be bounded by transport sector boundaries 1030 that are aligned with cryptographic blocks.

The watermark descriptor 830 may include: a bit count 832, an associated packet sequence number 834, an insertion number and a flags field 838. The bit count 832 may be used to identify a location within a watermark message 650. The associated packet sequence number 834 may be used to identify the first of the processed content packets 810 to be used in inserting a message 650 into a watermarked transport stream 660. The insertion number 836 may be used to indicate the number of associated carrier packets (dependent upon the message 650) that may be inserted into the watermarked transport stream 660. The flags field 838 may be configured to indicate whether the second watermark data represents a first value or a second value. The watermark descriptor may be implemented as a packet adaptation field. In some embodiments, the packet adaptation field may be kept in the clear.

Additionally, security data 840 may be included in the processed transport stream 630. This security data may be used in numerous well know ways, such as to verify integrity of the processed transport stream 630. For example, the security data could be a checksum value that is used to verify that all or part of the data in the processed transport stream 630 have not been corrupted or tampered with.

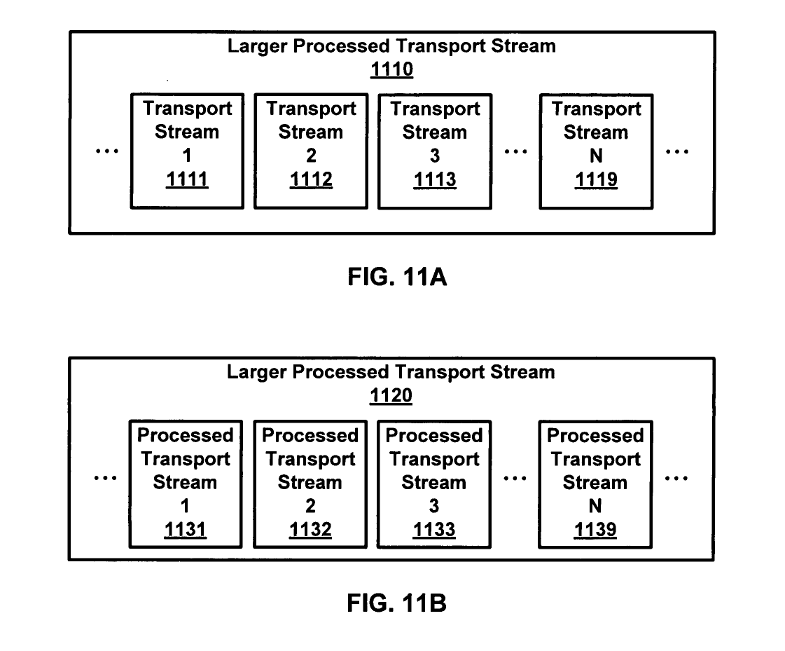

FIG. 11A is a block diagram of a larger transport stream 1110 as per an aspect of an embodiment of the present invention. This diagram illustrates that a multitude of transport streams 1111, 1112, 1113, and 1119 may be included in a larger transport stream 1110. This allows each of the multitude of transport streams 1111, 1112, 1113, and 1119 to be independently watermarked (or not). In such a case, each of the multitudes of transport streams 1111, 1112, 1113, and 1119 may be watermarked with completely messages. Alternatively, a single message may be spread out among individual several of the multitude of transport streams 1111, 1112, 1113, and 1119. Similarly, FIG. 11B illustrates that a multitude of processed transport streams 1131, 1132, 1133, and 1139 may be included in a larger processed transport stream 1120.

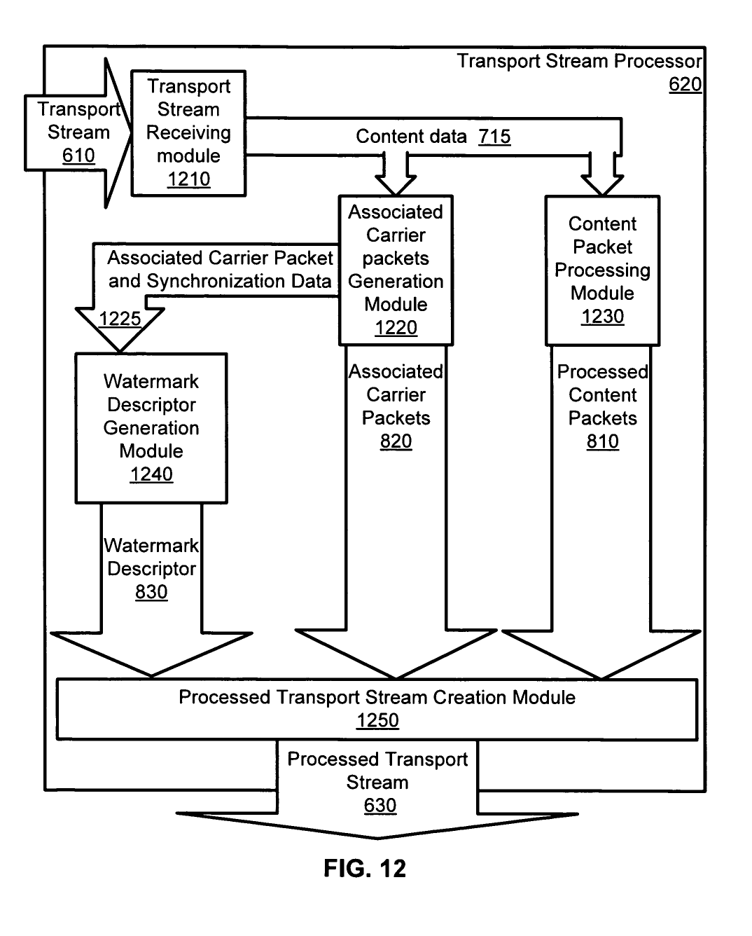

FIG. 12 is an expanded block diagram of a transport stream processor as per an aspect of an embodiment of the present invention. The transport stream processor 620 may be used to process a transport stream 610 for watermarking with a message 650. The transport stream processor 620 may include: a transport stream receiving module 1210; a content packet processing module 1230; an associated carrier packets generation module 1220; a watermark descriptor generation module 1240; and a processed transport stream creation module 1250.

The transport stream receiving module 1210 may be configured to receive the transport stream 610. In some embodiments, the transport stream may be part of a larger transport stream 1110. Content data 715 may be passed along with other relevant data to the associated carrier packets generation module 1220 and the content packet processing module 1230. The content packet processing module 1230 may be configured to generate processed content packets 810. The associated carrier packets generation module 1220 may be configured to generate associated carrier packets 820. The watermark descriptor generation module 1240 may be configured to generate a watermark descriptor 830 for a group of the associated carrier packets 820 using data 1225 determined by the associated carrier packets generation module 1220. Finally, the processed transport stream creation module 1250 combines the associated carrier packets 820, the processed content packets 830 and the watermark descriptor 1310 into a processed transport stream 630.

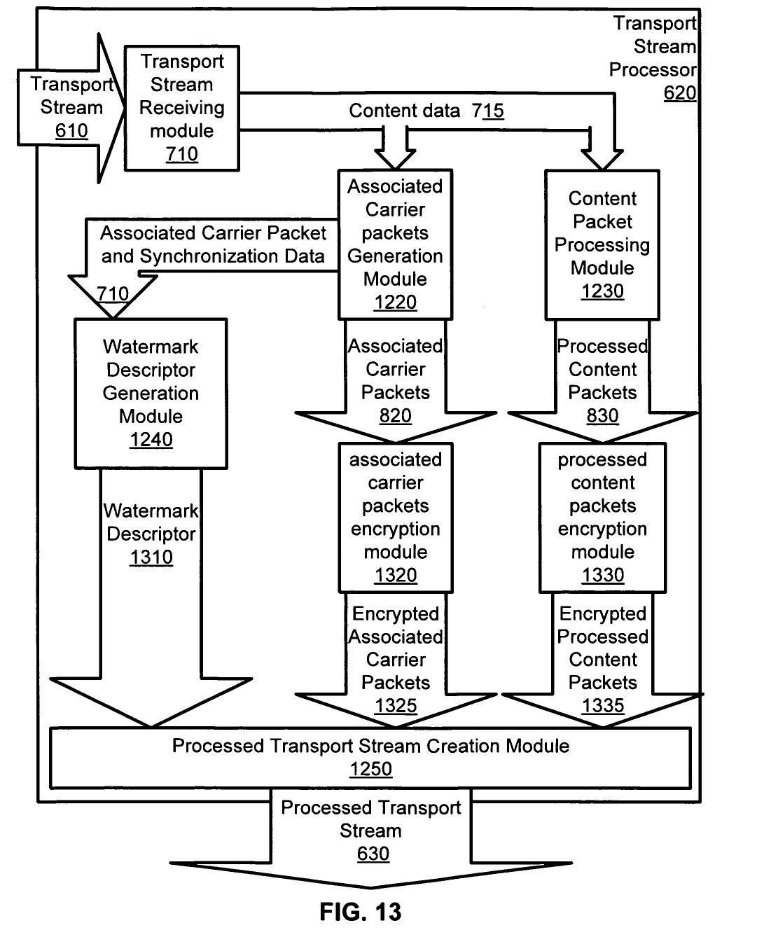

FIG. 13 is an expanded block diagram of an alternative transport stream processor as per an aspect of an embodiment of the present invention. This embodiment is similar to the embodiment illustrated in FIG. 12 with the addition of a processed content packets encryption module 1330 to generate encrypted processed content packets 1335 from processed content packets 830 and an encrypted associated carrier packets encryption module 1320 to generate encrypted associated carrier packets 1325 from the associated carrier packets 820. Additionally, the processed transport stream creation module 1250 in this embodiment combines the encrypted associated carrier packets 1325, the encrypted processed content packets 13350 and the watermark descriptor 1310 into a processed transport stream 630. The addition of these two modules help enable the processed transport stream watermarker 640 to watermark encrypted data streams without having to perform additional decryption and re-encryption steps.

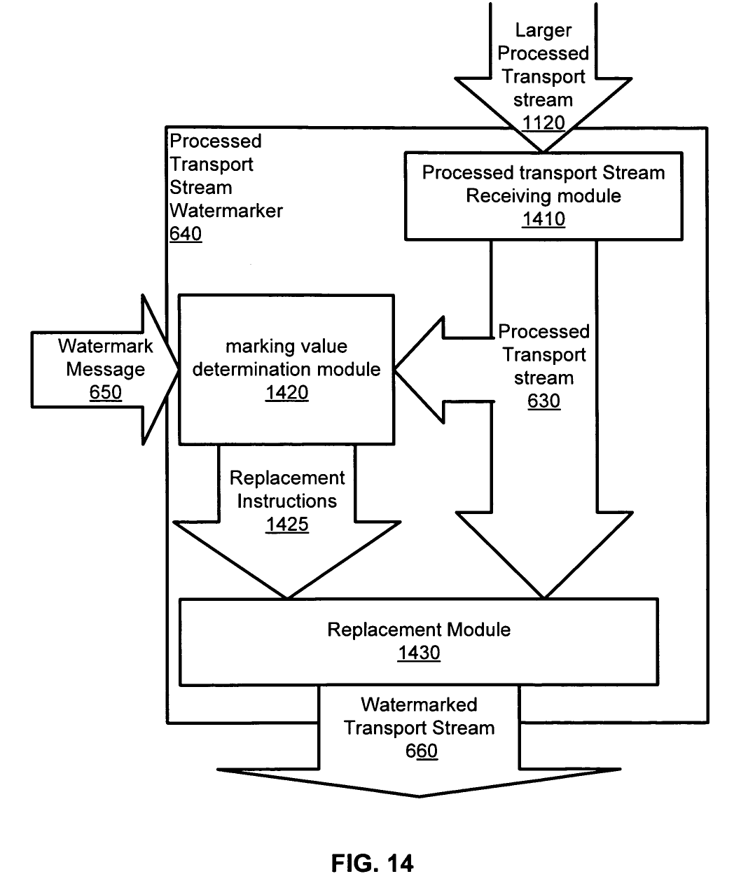

FIG. 14 is an expanded block diagram of a processed transport stream watermarker 640 as per an aspect of an embodiment of the present invention. A processed transport stream watermarker 640 may include: a processed transport stream receiving module 1410, a marking value determination module 1420; and a replacement module 1430. The processed transport stream receiving module 1410 is preferably configured to receive all or part of a larger processed transport stream 1120. The marking value determination module 1420 is preferably configured to determine a marking value or watermark message 650 by examining the location within the watermark message 650 identified by the bit count 832. The marking value 650 should indicate if the transport stream should be marked with the first watermark value or the second watermark value. The replacement module 1430 is preferably configured to replace the number of processed content packets 810 indicated by the insertion number 836 starting with the associated carrier packet 820 identified by the associated packet sequence number 834 if the marking value 650 indicates that the transport stream 630 should be marked with the second watermark value.

Each of the processed content packets 810 may include a content packet header. Similarly, each of the associated carrier packets 820 may include a carrier packet header. The replacement module may now insert the watermark indicated by the watermark message 650 by coping each of the content packet headers over each of the carrier packet headers; and then discard the processed content packets 810. This replacing may further include replacing at least part of the carrier packet with filler data. An alternative method to insert the watermark involves exchanging at least part of the processed content packets 810 with at least part of the associated carrier packets 820 according to the watermark message 650.

The transport stream watermarker 640 may be implemented in any number of locations including: in a hardware based content processor; in a software based content process; in an end point device; in a set top box; in an intermediate processor; in a multiplexer; or in a video on demand server.

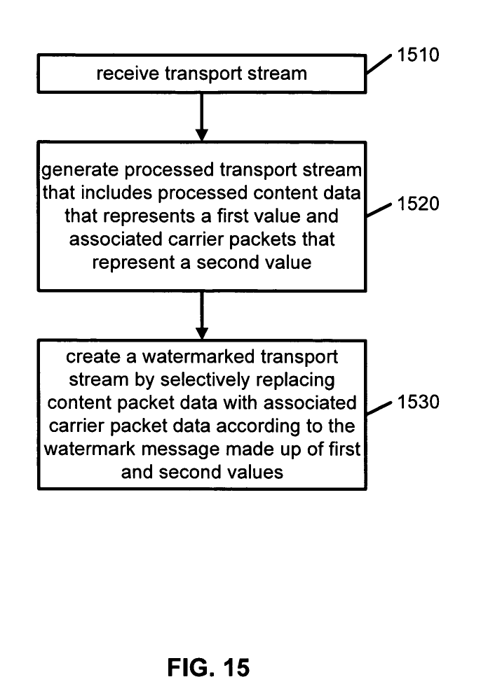

Up until now, most of the description of embodiments has been around functional modules. However, some embodiments maybe described and/or implemented as a series of actions. FIGS. 15 through 19 are flow diagrams that describe actions that may be used in implementing various aspects of several embodiments of the present invention.

FIG. 15 is a flow diagram showing the creation of a watermarked transport stream 660 as per an aspect of an embodiment of the present invention. At 1510, a transport stream 610 such as that described in FIG. 7 may be received. At 1520, a processed transport stream 630 described in FIG. 8 may be generated using content data 715 from the transport stream 610. The processed transport stream 630 should include processed content data 815 that represents a first value (e.g. ‘0’) and associated carrier packets 820 that represents a second value (e.g. ‘1’). At 1530, a watermarked transport stream 660 may be created by selectively replacing content packets 810 with associated carrier packets 820 in accordance with a watermark message 650 made up of first and second values.

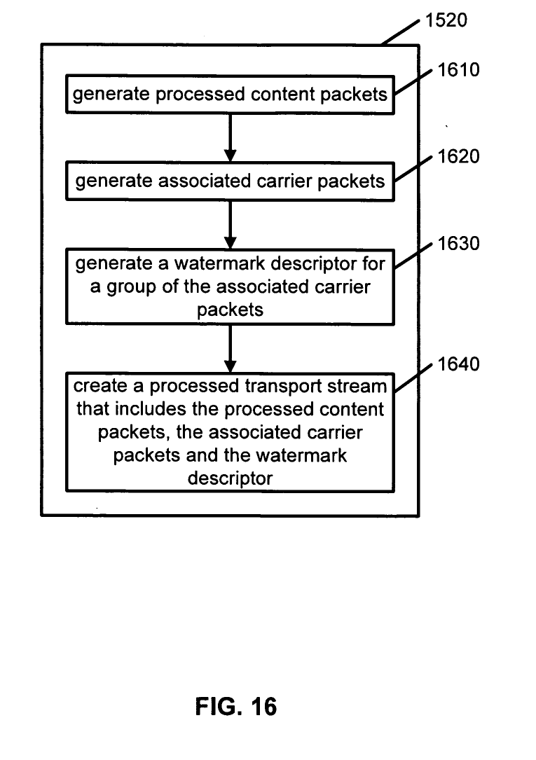

FIG. 16 is a flow diagram showing the creation of a processed transport stream 630 as per an aspect of an embodiment of the present invention. Basically, this diagram is a one of several possible expansions of action 1520. At 1610, processed content packets 810 may be generated. These processed content packets 810 preferably includes processed content data 815 that is perceived by a human as being relatively equivalent to content data 715, but is detectable by a computer as a having a first watermark value. At 1620, associated carrier packets 820 may be generated. These associated carrier packets 820 preferably includes replacement watermark data 825 that is perceived by a human as being relatively equivalent to content data 715, but is detectable by a computer as a having a second watermark value. At 1630, a watermark descriptor 830 (such as that described in FIG. 8) may be generated for a group of the associated carrier packets 820. The watermark descriptor 830 preferably contains information that may be used to facilitate the substitution of associated carrier packets 820 for the processed content packets 810 according to watermark message 650. Finally, at 1640, a processed transport stream 630 may be created that includes the processed content packets 810, the associated carrier packets 820, and the watermark descriptor 830.

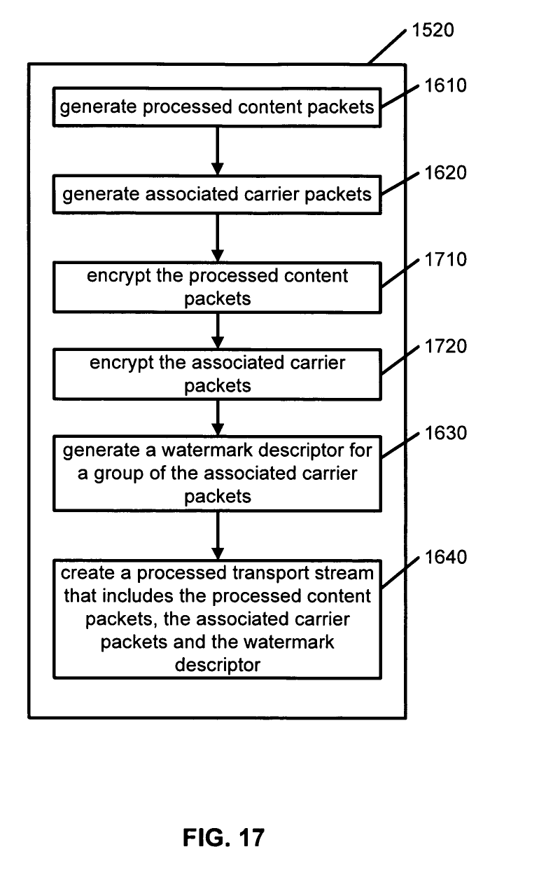

FIG. 17 is a flow diagram showing an alternative method to create a processed transport stream 630 as per an aspect of an embodiment of the present invention. The actions illustrated in this diagram parallel the actions in FIG. 16 with the addition of actions 1710 and 1720. At 1710, the processed content packets 810 are encrypted and at 1720 the associated carrier packets 820 are encrypted. Encrypting these packets 810 and 820 at this preprocessing stage enable the future watermarking of the data stream in the encrypted domain real-time, thus reducing resources required by a watermarker 640.

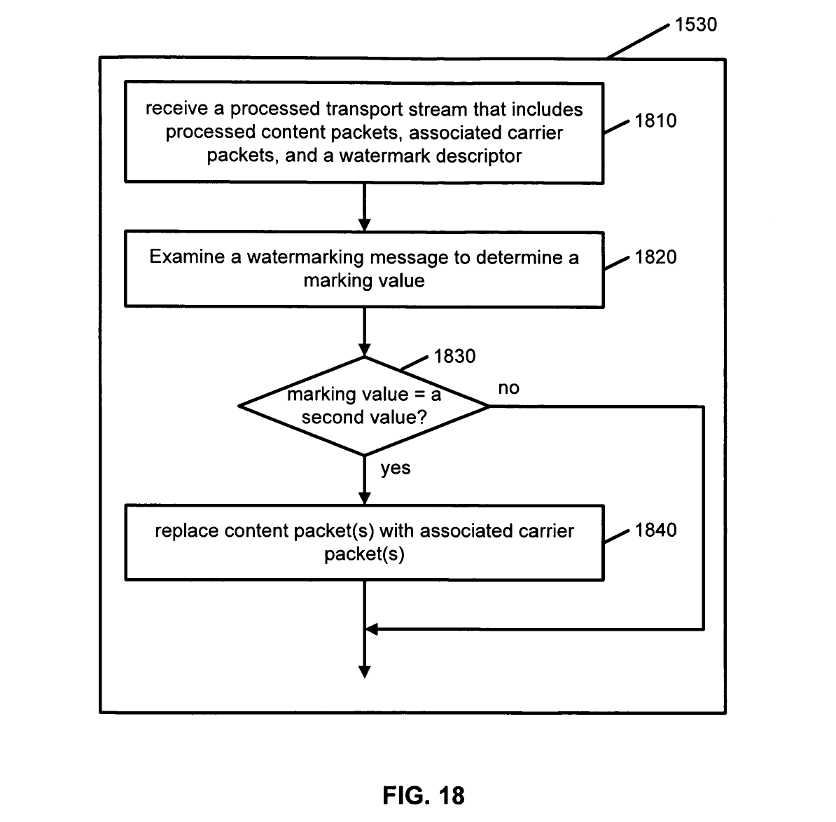

FIG. 18 is a flow diagram showing the marking of a processed transport stream 630 with a watermark message 650 as per an aspect of an embodiment of the present invention. Basically, this diagram is a one of several possible expansions of action 1530. At 1810, a processed transport stream 630 that includes processed content packets 810, associated carrier packets 820 and a watermark descriptor 830 may be received. A watermark message 650 may then be examined to determine a marking value at 1820. If the marking value is equivalent to a second value, then processed content packets 810 may be replaced by its paired associated carrier packets 820 at 1840.

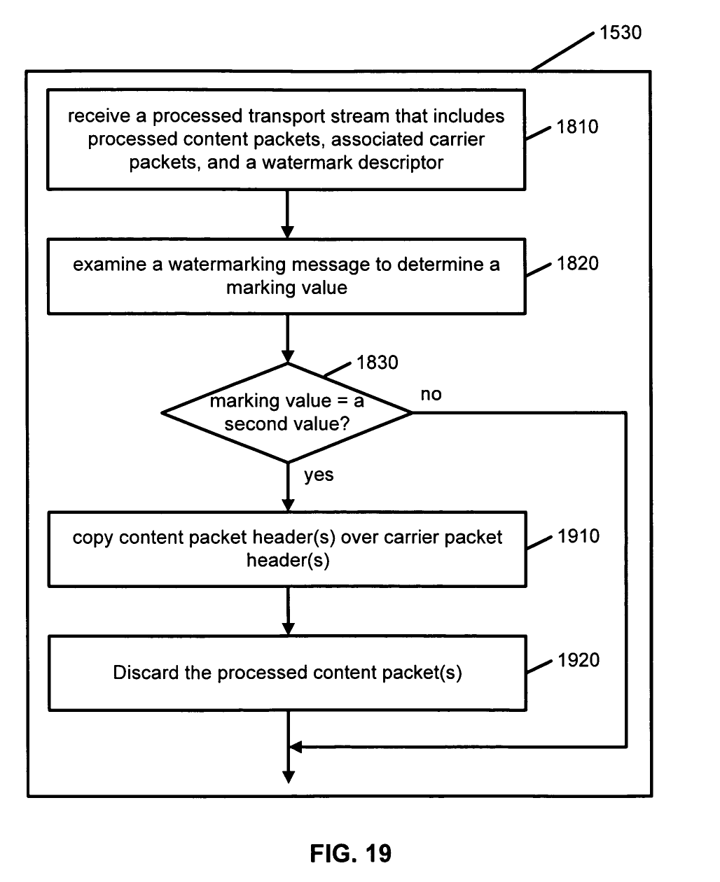

However, one skilled in the art will recognize that there are other equivalent actions that may be taken to create a watermarked transport stream 660 from a processed transport stream 630. FIG. 19 is a flow diagram showing one of many possible examples of such an alternative method for marking a processed transport stream with a watermark message as per an aspect of an embodiment of the present invention. This diagram is similar to the diagram in FIG. 18 except that the replacement of the watermark data shown previously in 1840 is now done in 1910 and 1920. At 1910, content packet header(s) may be copied over carrier packet header(s). and then the processed content packet(s) discarded at 1920.

While various embodiments of the present invention have been described above, it should be understood that they have been presented by way of example, and not limitation. It will be apparent to persons skilled in the relevant art that various changes in form and detail can be made therein without departing from the spirit and scope of the present invention. In fact, after reading the above description, it will be apparent to one skilled in the relevant art how to implement the invention in alternative embodiments. Thus, the present invention should not be limited by any of the above described exemplary embodiments. In particular, it should be noted that, for example purposes, the above explanation has focused on the examples of specific embodiments. However, those experienced in the art will realize that multiple other embodiments, including, but not limited to ones disclosed, can be used. For example, throughout this disclosure, watermark message 150 has been described as if it is a message containing a series of two values. One skilled in the art will recognize that the innovations taught here could be expanded to insert a watermark that includes a series of more that two values. To do this, one might include a second or third set of associated carrier packets that include replacement watermark data that represents the third and greater values that may be switched with the processed content packets 810.

In addition, it should be understood that any figures, schematic diagrams, system diagrams, or examples which highlight the functionality and advantages of the present invention, are presented for example purposes only. The architecture of the present invention is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

Furthermore, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

The present invention can be made from a variety of materials, in a variety of shape and size, for a variety of purpose. The scope of the present invention is limited only by the claims as follows.

What is claimed is:

1. A method for processing a transport stream for watermarking with a message, the method comprising:
a) receiving the transport stream, the transport stream including content packets, the content packets including content data;
b) generating processed content packets using the content data, the processed content packets including processed content data; the processed content data representing a first watermark value, the processed content packets bounded by first transport sector boundaries;
c) generating associated carrier packets, the associated carrier packets being associated with the processed content packets, the associated carrier packets including replacement watermark data for processed content data, the replacement watermark data representing a second watermark value, the associated carrier packets bounded by second transport sector boundaries;
d) generating a watermark descriptor for a group of the associated carrier packets, the watermark descriptor including synchronization data; and
e) creating a processed transport stream, the processed transport stream including:
i) the processed content packets;
ii) the associated carrier packets; and
iii) the watermark descriptor.

2. The method according to claim 1, further including:
a) encrypting the processed content packets, the first transport sector boundaries configured to align with first cryptographic blocks; and
b) encrypting the associated carrier packets, the second transport sector boundaries configured to align with second cryptographic blocks.

3. The method according to claim 1, wherein the synchronization data includes:
a) a bit count, the bit count identifying a location within the message;
b) an associated packet sequence number, the associated packet sequence number identifying the first of the processed content packets;
c) an insertion number, the insertion number indicating the number of associated carrier packets; and
d) a flags field configured to indicate whether the second watermark data represents a first value or a second value.

4. The method according to claim 1, wherein the associated carrier packets are interleaved before the processed content packets.

5. The method according to claim 1, wherein the transport stream is an unencrypted transport stream.

6. The method according to claim 1, wherein the processed transport stream becomes part of a larger transport stream.

7. The method according to claim 1, wherein the transport stream is at last one of the following:
a) an MPEG2 transport stream; and
b) an MPEG2 program stream.

8. The method according to claim 1, wherein the processed content packets are packaged according to at least one of the following formats:
a) Quicktime;
b) 3GPP; and
c) MPEG4.

9. The method according to claim 1, wherein the content data includes at least one of the following:
a) video data; and
b) audio data.

10. The method according to claim 1, wherein the watermark descriptor is a packet adaptation field, the packet adaptation field being in the clear.

11. The method according to claim 1, wherein the processed transport stream is made available to a content processor, the content processor being at least one of the following:
a) a hardware based content processor; or
b) a software based content process; or
c) a combination of the above; and
wherein the content processor is included in one of the following:
d) an end point device;
e) a set top box;
f) an intermediate processor;
g) a multiplexer; or
h) a video on demand server.

12. A method for watermarking a transport stream, the method comprising:
a) receiving the transport stream, the transport stream being part of a larger transport stream, the transport stream including:
i) processed content packets, the processed content packets including processed content data; the processed content data representing a first watermark value, the encrypted content packets bounded by first transport sector boundaries;
ii) associated carrier packets, the associated carrier packets associated with the content packets, the associated carrier packets including replacement watermark data for the processed content data, the replacement watermark data representing a second watermark value, the encrypted carrier packets bounded by second transport sector boundaries; and
iii) a watermark descriptor, the watermark descriptor including:
(1) a bit count, the bit count identifying a location within the message;
(2) an associated packet sequence number, the associated packet sequence number identifying the first of the processed content packets;
(3) an insertion number, the insertion number indicating the number of associated carrier packets; and
(4) a flags field configured to indicate whether the second watermark data represents a first value or a second value;
b) determining a marking value by examining the location within the message identified by the bit count, the marking value indicating if the transport stream should be marked with the first watermark value or the second watermark value; and
c) if the marking value indicates that the transport stream should be marked with the second watermark value, replacing the number of processed content packets indicated by the insertion number starting with the associated carrier packet identified by the associated packet sequence number.

13. The method for watermarking a transport stream according to claim 12, wherein:
i) the processed content packets are encrypted and the first transport sector boundaries are aligned with first cryptographic blocks; and
ii) the associated carrier packets are encrypted and the second transport sector boundaries are aligned with second cryptographic blocks.

14. The method for watermarking a transport stream according to claim 12, wherein:
a) each of the processed content packets includes a content packet header;
b) each of the associated carrier packets includes a carrier packet header; and
c) the replacing further includes:
i) copying each of the content packet headers over each of the carrier packet headers; and
ii) discarding the processed content packets.

15. The method for watermarking a transport stream according to claim 12, wherein the replacing further includes replacing at least part of the carrier packet with filler data.

16. The method for watermarking a transport stream according to claim 12, wherein the replacing further includes exchanging at least part of the processed content packets with at least part of the associated carrier packets.

17. The method according to claim 12, wherein the method is implemented in one of the following:
a) a hardware based content processor; or
b) a software based content process; or
c) a combination of the above; and
wherein the content processor is included in one of the following:
d) an end point device;
e) a set top box;
f) an intermediate processor;
g) a multiplexer; or
h) a video on demand server.

18. The method according to claim 12, further including using security data to determine if either the processed content packets or associated carrier packets have been tampered with, wherein the security data resides in the transport stream.

19. The method according to claim 12, wherein at least one of the processed content packets renders the content data unusable unless replaced by at least one of the associated carrier packets.

20. A processed transport stream, the processed transport stream comprising:
a) processed content packets, the processed content packets including processed content data; the processed content data representing a first watermark value, the processed content packets bounded by first transport sector boundaries;
b) associated carrier packets, the associated carrier packets associated with the processed content packets, the associated carrier packets including replacement watermark data for the processed content data, the replacement watermark data representing a second watermark value, the associated carrier packets bounded by second transport sector boundaries; and
c) a watermark descriptor, the watermark descriptor including:
i) a bit count, the bit count identifying a location within the message;
ii) an associated packet sequence number, the associated packet sequence number identifying the first of the processed content packets; and
iii) an insertion number, the insertion number indicating the number of associated carrier packets.
iv) a flags field configured to indicate whether the second watermark data represents a first value or a second value.

21. A processed transport stream according to claim 20, wherein:
a) the processed content packets are encrypted and the first transport sector boundaries are aligned with first cryptographic blocks; and
b) the associated carrier packets are encrypted and the second transport sector boundaries are aligned with second cryptographic blocks.

22. A processed transport stream according to claim 20, wherein the transport stream is part of a larger transport stream.

23. A processed transport stream according to claim 20, wherein the transport stream is at last one of the following:
a) an MPEG2 transport stream; and
b) an MPEG2 program stream.

24. A processed transport stream according to claim 20, wherein the content packets are packaged according to at least one of the following formats:
a) Quicktime;
b) 3GPP; and
c) MPEG4.

25. A processed transport stream according to claim 20, wherein the content data includes at least one of the following:
a) video data; and
b) audio data.

26. A processed transport stream according to claim 20, further including security data.

27. A transport stream processor for processing a transport stream for watermarking with a message, the transport stream processor comprising:
a) a transport stream receiving module, the transport stream receiving module configured to receive the transport stream, the transport stream including content packets, the content packets including content data;
b) a content packet processing module, the content packet processing module configured to generate processed content packets using the content data, the processed content packets including processed content data; the processed content data representing a first watermark value, the processed content packets bounded by first transport sector boundaries;
c) an associated carrier packets generation module, the associated carrier packets generation module configured to generate associated carrier packets, the associated carrier packets being associated with the processed content packets, the associated carrier packets including replacement watermark data for processed content data, the replacement watermark data representing a second watermark value, the associated carrier packets bounded by second transport sector boundaries;
d) a watermark descriptor generation module, the watermark descriptor generation module configured to generate a watermark descriptor for a group of the associated carrier packets, the watermark descriptor including synchronization data; and
e) a processed transport stream creation module, the processed transport stream creation module configured to create a processed transport stream, the processed transport stream including:
i) the processed content packets;
ii) the associated carrier packets; and
iii) the watermark descriptor.

28. The transport stream processor according to claim 27, further including:
a) a processed content packets encryption module, the processed content packets encryption module configured to encrypt the processed content packets, the first transport sector boundaries configured to align with first cryptographic blocks; and
b) an associated carrier packets encryption module, the associated carrier packets encryption module configured to encrypt the associated carrier packets, the second transport sector boundaries configured to align with second cryptographic blocks.

29. The transport stream processor according to claim 27, wherein the synchronization data includes:
a) a bit count, the bit count identifying a location within the message;
b) an associated packet sequence number, the associated packet sequence number identifying the first of the processed content packets;
c) an insertion number, the insertion number indicating the number of associated carrier packets; and
d) a flags field configured to indicate whether the second watermark data represents a first value or a second value.

30. The transport stream processor according to claim 27, wherein the associated carrier packets are interleaved before the processed content packets.

31. The transport stream processor according to claim 27, wherein the transport stream is an unencrypted transport stream.

32. The transport stream processor according to claim 27, wherein the processed transport stream becomes part of a larger transport stream.

33. The transport stream processor according to claim 27, wherein the transport stream is at last one of the following:
a) an MPEG2 transport stream; and
b) an MPEG2 program stream.

34. The transport stream processor according to claim 27, wherein the processed content packets are packaged according to at least one of the following formats:
a) Quicktime;
b) 3GPP; and
c) MPEG4.

35. The transport stream processor according to claim 27, wherein the content data includes at least one of the following:
a) video data; and
b) audio data.

36. The transport stream processor according to claim 27, wherein the watermark descriptor is a packet adaptation field, the packet adaptation field being in the clear.

37. The transport stream processor according to claim 27, wherein the processed transport stream is made available to a content processor, the content processor being at least one of the following:
a) a hardware based content processor; or
b) a software based content process; or
c) a combination of the above; and
wherein the content processor is included in one of the following:
d) an end point device;
e) a set top box;
f) an intermediate processor;
g) a multiplexer; or
h) a video on demand server.

38. A processed transport stream watermarker comprising:
a) a processed transport stream receiving module, the processed transport stream receiving module configured to receive the processed transport stream, the processed transport stream being part of a larger transport stream, the processed transport stream including:
i) processed content packets, the processed content packets including processed content data; the processed content data representing a first watermark value, the encrypted content packets bounded by first transport sector boundaries;
ii) associated carrier packets, the associated carrier packets associated with the content packets, the associated carrier packets including replacement watermark data for the processed content data, the replacement watermark data representing a second watermark value, the encrypted carrier packets bounded by second transport sector boundaries; and
iii) a watermark descriptor, the watermark descriptor including:
(1) a bit count, the bit count identifying a location within a watermark message;
(2) an associated packet sequence number, the associated packet sequence number identifying the first of the processed content packets;
(3) an insertion number, the insertion number indicating the number of associated carrier packets; and
(4) a flags field configured to indicate whether the second watermark data represents a first value or a second value;
b) a marking value determination module, the marking value determination module configured to determine a marking value by examining the location within the watermark message identified by the bit count, the marking value indicating if the transport stream should be marked with the first watermark value or the second watermark value; and
c) a replacement module, the replacement module configured to replace the number of processed content packets indicated by the insertion number starting with the associated carrier packet identified by the associated packet sequence number if the marking value indicates that the transport stream should be marked with the second watermark value.

39. The transport stream watermarker according to claim 38, wherein:
i) the processed content packets are encrypted and the first transport sector boundaries are aligned with first cryptographic blocks; and
ii) the associated carrier packets are encrypted and the second transport sector boundaries are aligned with second cryptographic blocks.

40. The transport stream watermarker according to claim 38, wherein:
a) each of the processed content packets includes a content packet header;
b) each of the associated carrier packets includes a carrier packet header; and
c) the replacement module is further configured to:
i) copy each of the content packet headers over each of the carrier packet headers; and
ii) discard the processed content packets.

41. The transport stream watermarker according to claim 38, wherein the replacing further includes replacing at least part of the carrier packet with filler data.

42. The transport stream watermarker according to claim 38, wherein the replacement module is further configured to exchange at least part of the processed content packets with at least part of the associated carrier packets.

43. The transport stream watermarker according to claim 38, wherein at least part of the transport stream is implemented in one of the following:
a) a hardware based content processor;
b) a software based content process;
c) an end point device;
d) a set top box;
e) an intermediate processor;
f) a multiplexer; and
g) a video on demand server.
